(19) United States
(12) Patent Application Publication
(10) Pub. No.: US 2026/0189448 A1
(43) Pub. Date: Jul. 2, 2026

(54) SIGNAL PROCESSING METHOD, TRANSMIT-END DEVICE, AND RECEIVE-END DEVICE

(71) Applicant: QUECTEL WIRELESS SOLUTIONS CO., LTD., Shanghai (CN)

(72) Inventors: Zheng ZHAO, Shanghai (CN); Ling LYU, Frisco, TX (US)

(21) Appl. No.: 19/432,680

(22) Filed: Dec. 24, 2025

Related U.S. Application Data
(63) Continuation of application No. PCT/CN2024/143350, filed on Dec. 27, 2024.

(51) Int. Cl. H04L 27/26

(52) U.S. Cl. CPC H04L 27/2627

(57) ABSTRACT

Provided are a signal processing method, a transmit-end device, and a receive-end device. One example method includes: performing modulation processing on a first signal to obtain a second signal, wherein the second signal comprises a third signal obtained based on a first signal modulation scheme and a fourth signal obtained based on a second signal modulation scheme, the first signal modulation scheme comprises orthogonal frequency division multiplexing (OFDM), and the second signal modulation scheme comprises a signal modulation scheme other than OFDM.

### CROSS-REFERENCE TO RELATED APPLICATIONS

This application is a continuation of International Application No. PCT/CN2024/143350, filed on Dec. 27, 2024, the disclosure of which is hereby incorporated by reference in its entirety.

### TECHNICAL FIELD

The present application relates to the field of communications technologies, and more specifically, to a signal processing method, a transmit-end device, and a receive-end device.

### BACKGROUND

With development of wireless communications, new application requirements increase continuously, and many new scenarios and services are to be supported, for example, integrated sensing and communication (integrated sensing and communication, ISAC) and space-air-ground integrated (space-air-ground integrated, SAGI) communication. Therefore, for a mobile communications network, not only a communication procedure is to be optimized, but also a signal processing capability is to be improved, to improve signal transmission performance.

### SUMMARY

The present application provides a signal processing method, a transmit-end device, and a receive-end device. Various aspects involved in the present application are described below.

According to a first aspect, a signal processing method is provided, including: performing modulation processing on a first signal to obtain a second signal, where the second signal includes a third signal obtained based on a first signal modulation scheme and a fourth signal obtained based on a second signal modulation scheme, the first signal modulation scheme includes OFDM, and the second signal modulation scheme includes a signal modulation scheme other than OFDM.

According to a second aspect, a signal processing method is provided, including: performing demodulation processing on a second signal to obtain a first signal, where the second signal includes a third signal and a fourth signal, the first signal includes a first part obtained through demodulation processing performed on the third signal in a demodulation scheme corresponding to a first signal modulation scheme and a second part obtained through demodulation processing performed on the fourth signal in a demodulation scheme corresponding to a second signal modulation scheme, the first signal modulation scheme includes OFDM, and the second signal modulation scheme includes a signal modulation scheme other than OFDM.

According to a third aspect, a transmit-end device is provided, including: a processing unit, performing modulation processing on a first signal to obtain a second signal, where the second signal includes a third signal obtained based on a first signal modulation scheme and a fourth signal obtained based on a second signal modulation scheme, the first signal modulation scheme includes OFDM, and the second signal modulation scheme includes a signal modulation scheme other than OFDM.

According to a fourth aspect, a receive-end device is provided, including: a processing unit, performing demodulation processing on a second signal to obtain a first signal, where the second signal includes a third signal and a fourth signal, the first signal includes a first part obtained through demodulation processing performed on the third signal in a demodulation scheme corresponding to a first signal modulation scheme and a second part obtained through demodulation processing performed on the fourth signal in a demodulation scheme corresponding to a second signal modulation scheme, the first signal modulation scheme includes OFDM, and the second signal modulation scheme includes a signal modulation scheme other than OFDM.

According to a fifth aspect, a transmit-end device is provided, including a transceiver, a memory, and a processor. The memory is configured to store a program. The processor is configured to invoke the program in the memory and control the transceiver to receive or transmit a signal, so that the transmit-end device performs the method according to the first aspect.

According to a sixth aspect, a receive-end device is provided, including a transceiver, a memory, and a processor. The memory is configured to store a program. The processor is configured to invoke the program in the memory and control the transceiver to receive or transmit a signal, so that the receive-end device performs the method according to the second aspect.

According to a seventh aspect, an apparatus is provided, including: a processor, invoking a program from a memory, to cause the apparatus to perform the method according to either the first aspect or the second aspect.

According to an eighth aspect, a chip is provided, including: a processor, invoking a program from a memory, to cause a device installed with the chip to perform the method according to the first aspect or the second aspect.

According to a ninth aspect, a computer-readable storage medium is provided. The computer-readable storage medium stores a program. The program causes a computer to perform the method according to the first aspect or the second aspect.

According to a tenth aspect, a computer program product is provided, including a program. The program causes a computer to perform the method according to the first aspect or the second aspect.

According to an eleventh aspect, a computer program is provided. The computer program causes a computer to perform the method according to the first aspect or the second aspect.

The present application provides two different signal modulation schemes, that is, the first signal modulation scheme (for example, OFDM) and the second signal modulation scheme (for example, the signal modulation scheme other than OFDM), to perform modulation processing on the first signal. The obtained second signal includes the third signal obtained based on the first signal modulation scheme and the fourth signal obtained based on the second signal modulation scheme. Therefore, coordinated transmission of signals in two different modulation schemes is implemented, to facilitate improvement of signal transmission performance.

### BRIEF DESCRIPTION OF THE DRAWINGS

FIG. 1 is an example diagram of a system architecture of a wireless communications system to which an embodiment of the present application is applicable.

FIG. 2 is a schematic diagram of a future communication scenario.

FIG. 3 is a schematic flowchart of OFDM processing to which an embodiment of the present application is applicable.

FIG. 4 is a schematic flowchart of OTFS processing to which an embodiment of the present application is applicable.

FIG. 5 is a schematic flowchart of a signal processing method according to an embodiment of the present application.

FIG. 6 is a schematic diagram of transmitting a third signal and a fourth signal in a frequency division manner according to an embodiment of the present application.

FIG. 7 is a schematic diagram of transmitting a third signal and a fourth signal in a frequency division manner according to an embodiment of the present application.

FIG. 8 is a schematic diagram of transmitting a third signal and a fourth signal in a time division manner according to an embodiment of the present application.

FIG. 9 is a schematic diagram of transmitting a third signal and a fourth signal in a time division manner according to an embodiment of the present application.

FIG. 10 is a schematic diagram of a possible implementation of a signal processing method shown in FIG. 6.

FIG. 11 is a schematic diagram of an example of serial-to-parallel transform shown in FIG. 10.

FIG. 12 is a schematic flowchart of a signal processing method according to an embodiment of the present application.

FIG. 13 is a schematic structural diagram of a transmit-end device according to an embodiment of the present application.

FIG. 14 is a schematic structural diagram of a receive-end device according to an embodiment of the present application.

FIG. 15 is a schematic diagram of an apparatus for communication according to an embodiment of the present application.

### DETAILED DESCRIPTION OF THE EMBODIMENTS

The technical solutions in the present application are described below with reference to the accompanying drawings.

### Wireless Communications System

FIG. 1 is an example diagram of a system architecture of a wireless communications system 100 to which an embodiment of the present application is applicable. The wireless communications system 100 may include a network device 110 and a terminal device 120. The network device 110 may be a device in communication with the terminal device 120. The network device 110 may provide network coverage for a specific geographical region, and may communicate with the terminal device 120 located with the coverage. The terminal device 120 may access a network such as a wireless network through the network device 110. Optionally, the wireless communications system 100 may further include other network entities such as a network controller and a mobility management entity. This is not limited in embodiments of the present application.

It should be understood that the technical solutions of embodiments of the present application may be applied to various communications systems, such as a 5th generation (fifth generation, 5G) system, a new radio (new radio, NR) system, a long term evolution (long term evolution, LTE) system, an LTE frequency division duplex (frequency division duplex, FDD) system, and an LTE time division duplex (time division duplex, TDD) system. The technical solutions provided in the present application may further be applied to a future communications system, such as a 6th generation mobile communications system or a satellite communications system.

The terminal device in embodiments of the present application may also be referred to as a user equipment (user equipment, UE), an access terminal, a subscriber unit, a subscriber station, a mobile site, a mobile station (mobile station, MS), a mobile terminal (mobile terminal, MT), a remote station, a remote terminal, a mobile device, a user terminal, a terminal, a wireless communications device, a user agent, or a user apparatus. The terminal device in embodiments of the present application may be a device providing a user with voice and/or data connectivity and capable of connecting people, objects, and machines, such as a handheld device or a vehicle-mounted device having a wireless connection function. The terminal device may alternatively be a mobile phone (mobile phone), a tablet computer (Pad), a notebook computer, a palmtop computer, a mobile Internet device (mobile internet device, MID), a wearable device, a virtual reality (virtual reality, VR) device, an augmented reality (augmented reality, AR) device, a wireless terminal in industrial control (industrial control), a wireless terminal in self driving (self driving), a wireless terminal in remote medical surgery (remote medical surgery), a wireless terminal in a smart grid (smart grid), a wireless terminal in transportation safety (transportation safety), a wireless terminal in a smart city (smart city), a wireless terminal in a smart home (smart home), or the like. Optionally, the terminal device may function as a base station. For example, the terminal device may function as a scheduling entity that provides a sidelink signal between terminal devices in vehicle-to-everything (vehicle to everything, V2X), device-to-device (device to device, D2D), or the like. For example, a cellular phone and a vehicle communicate with each other by using a sidelink signal. A cellular phone and a smart home device communicate with each other, without relay of a communication signal through a base station.

The network device in embodiments of the present application may be a device configured to communicate with the terminal device. The network device may be an access network device or a radio access network device. For example, the network device may be a base station. The base station may broadly cover various names in the following, or may be interchangeable with the following names, for example, a NodeB (NodeB), an evolved NodeB (evolved NodeB, eNB), a next generation NodeB (next generation NodeB, gNB), a relay station, a transmitting and receiving point (transmitting and receiving point, TRP), a transmitting point (transmitting point, TP), a master eNode (MeNB), a secondary eNode (SeNB), a multi-standard radio (MSR) node, a home base station, a network controller, an access node, a wireless node, an access point (access point, AP), a transmission node, a transceiver node, a baseband unit (baseband unit, BBU), a remote radio unit (remote radio unit, RRU), an active antenna unit (active antenna unit, AAU), a remote radio head (remote radio head, RRH), a central unit (central unit, CU), a distributed unit (distributed unit, DU), and a positioning node. The base station may be a macro base station, a micro base station, a relay node, a donor node, an analogue, or a combination thereof. Alternatively, the base station may be a communications module, a modem, or a chip disposed in the device or the apparatus described above. Alternatively, the base station may be a mobile switching center, a device that functions as a base station in device-to-device D2D, vehicle-to-everything (vehicle-to-everything, V2X), and machine-to-machine (machine-to-machine, M2M) communication, a network-side device in a 6G network, a device that functions as a base station in a future communications system, or the like. The base station may support networks of the same access technology or different access technologies. A specific technology and a specific device used by the network device are not limited in embodiments of the present application. The base station may support networks of the same access technology or different access technologies. A specific technology and a specific device used by the network device are not limited in embodiments of the present application.

In addition, the base station may be fixed or mobile. For example, a helicopter or an unmanned aerial vehicle may be configured to function as a mobile base station, and one or more cells may move according to a location of the mobile base station. In another example, a helicopter or an unmanned aerial vehicle may be configured to function as a device in communication with another base station.

The network device and the terminal device may be deployed on land, including being indoors or outdoors, handheld, or vehicle-mounted, may be deployed on a water surface, or may be deployed on a plane, a balloon, or a satellite in the air. In embodiments of the present application, a scenario of the network device and the terminal device is not limited.

It should be understood that all or part of the functions of the communications device in the present application may also be implemented by software functions running on hardware, or by virtualization functions instantiated on a platform such as a cloud platform.

In wireless communication, a transmitted signal usually undergoes multipath propagation and reaches a receive end with different delays. In general, if a symbol gap is less than or close to a channel delay spread, unwanted inter symbol interference (inter symbol interference, ISI) is generated. The core of a multiple access manner and a waveform design is to synthetically generate a transmit waveform, so that symbols carrying information are transmitted most effectively over a propagation channel.

In LTE and NR (New Radio) systems, orthogonal frequency division multiplexing (orthogonal frequency division multiplexing, OFDM) gains a great success, and can convert a frequency selective channel into parallel frequency flat subchannels through multi-carrier transmission, thereby effectively reducing inter symbol interference and implementing flexible time-frequency resource allocation. However, OFDM also has some actual problems, for example, including:
relatively large cyclic prefix (cyclic prefix, CP) overheads;
a large peak-to-average power ratio (peak-to-average power ratio, PAPR);
severe inter-carrier inference (inter-carrier inference, ICI) in a high-speed moving scenario; and
high out-of-band emission (out-of-band emission, OOBE).

On an LTE uplink, a PAPR is reduced by using discrete Fourier transform (discrete Fourier transform, DFT) spread OFDM (DFT-s-OFDM). However, this may increase implementation complexity or reduce system performance. With development of wireless communications, new application requirements increase continuously. A mobile communications network not only is to further improve communication performance, but also is to support many new scenarios and services, for example, ISAC and SAGI. Therefore, the ability to support wireless sensing and high-speed movement is required to be considered during a multiple access design (or a waveform design).

In 2G and 3G times, a signal bandwidth is relatively small. OFDM is used from 4G, and OFDM is still used in 5G. Through OFDM, transmitted data is divided into a plurality of subchannels (or subcarriers) for parallel transmission, and each subcarrier carries a part of data at a low rate. During broadband transmission, orthogonality between subcarriers is used to reduce interference. Through subcarrier spectrum overlapping, subcarrier resources are fully utilized, and spectrum utilization is improved. In addition, in an OFDM system, inter symbol interference caused due to multi-path propagation may be, for example, alleviated through inserting a guard period (for example, a CP). In the OFDM system, when reception processing such as signal detection and channel estimation is performed, simple gain adjustment is performed on each subcarrier in frequency domain, and no complex time domain equalizer is required. Therefore, OFDM is easily combined with another technology, such as a multiple-input multiple-output multiple-input multiple-output (multiple input multiple output, MIMO) technology, to further improve system performance. Considering that an existing standard is designed based on OFDM, designing a new system standard without consideration of OFDM leads to enormous efforts, and such processing greatly affects an industrial map. Based on advantages of OFDM in existing systems, for example, high spectrum utilization, good orthogonality between users, low detection complexity, and easy combination with other technologies, coexistence of OFDM with other multiple access (or waveform) is considered in this embodiment of the present application.

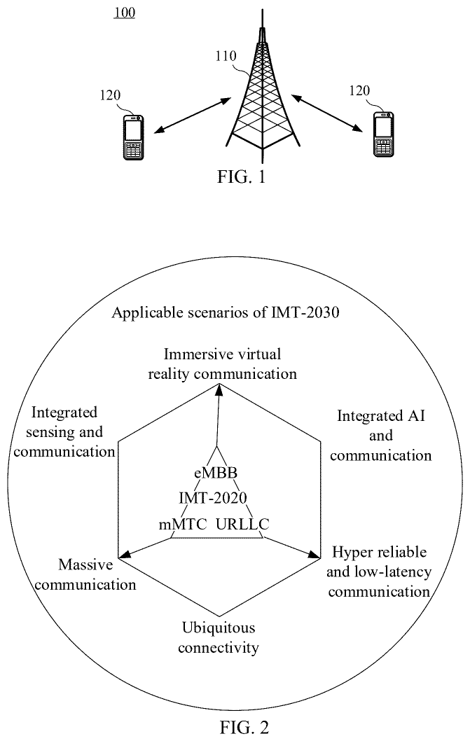

The international mobile telecommunications (international mobile telecommunications, IMT)-2030 (that is, 6G) defines six scenarios. For example, a main applicable scenario of IMT-2030 shown in FIG. 2 relates to aspects such as enhanced mobile broadband (enhanced mobile broadband, eMBB), IMT-2020, massive machine type communication (massive machine type communication, mMTC), and ultra-reliable and low latency communication (ultra-reliable and low latency communication, URLLC), and specifically relates to six major scenarios: immersive virtual reality communication (or, immersive communication), integrated sensing and communication (integrated sensing and communication), massive communication (massive communication), ubiquitous connectivity (ubiquitous connectivity), hyper reliable and low-latency communication (hyper reliable and low-latency communication), and integrated AI and communication (integrated AI and communication). In particular, integrated sensing and communication has been determined as one of six major application scenarios of 6G. 6G implements deep integration of communication and sensing, shares radio resources, and provides support for environment sensing and efficient communication.

When modeling is performed on a wireless channel, modeling is usually performed in time domain, frequency domain, or time-frequency (time-frequency, TF) domain. For the OFDM system, a signal may be converted into frequency domain, and complex processing of channel convolution due to a multipath delay may be reduced through frequency domain analysis. For a wireless channel with relatively few taps, processing in time domain is sometimes more convenient. Some signals present a changing characteristic in time domain and frequency domain, and better show features of the signals during time-frequency combination processing. A wavelet change may be considered as time-frequency processing. However, the wireless channel may be affected by time-frequency domain selective (time-frequency domain selective, TFDS) fading. Relatively speaking, with multipath spatial sparsity, the wireless channel can also be represented in delay-Doppler (delay-doppler, DD) domain, and can be described with only a small quantity of channel coefficients. High-frequency transmission and extremely large-scale multiple-input multiple-output (XL-MIMO) of a millimeter wave (mm wave) or a terahertz (THz) frequency band are two potential technical highlights of 6G. This makes the wireless channel sparser than a conventional channel below 6 GHz. In addition, a millimeter wave XL-MIMO system has high resolution and rich design freedom in spatial domain. Based on high spatial resolution of multiple antennas and millimeter waves in 6G, channel characteristics may be captured by using a status (for example, a delay, a Doppler frequency, and a normalization angle) of a primary scatter in a propagation environment. These characteristics may be represented in the delay-Doppler domain. It is possible to unify environment sensing and channel estimation by extracting individual multipath characteristics while serving both communication and sensing rather than merely estimating composite channel characteristics.

For this reason, a delay-Doppler domain waveform design has received more attention in recent years due to its robustness to channel fluctuation in a high-speed moving scenario and its potential for high-performance ISAC. A typical example of a DD domain waveform is orthogonal time-frequency space (orthogonal time frequency space, OTFS). Generally, the wireless channel undergoes time-frequency domain selective fading. A main idea of OTFS is to convert each DD tap to an entire time-frequency plane, to use all multipath diversity. This may also be implemented in a similar manner through vector OFDM (VOFDM), so that OTFS or VOFDM has an advantage over conventional OFDM in TFDS fading channels.

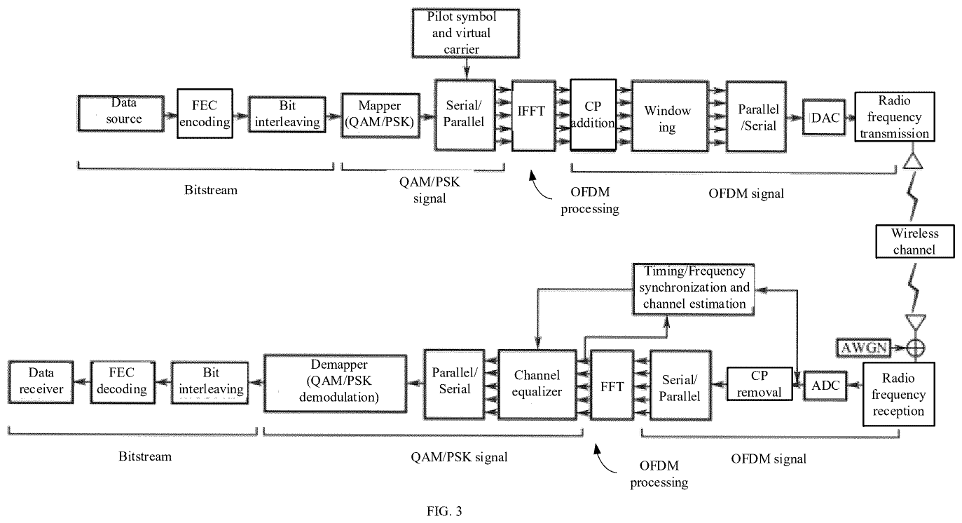

FIG. 3 shows an implementation process of OFDM. A signal processing procedure in an upper row corresponds to a transmit end, and a signal processing procedure in a lower row corresponds to a receive end. OFDM processing at the transmit end includes performing inverse fast Flourier transform (inverse fast flourier transform, IFFT) on a signal obtained after mapping and serial-to-parallel transform, and then performing operations such as adding a CP, windowing, parallel-to-serial change, and digital-to-analog conversion (digital-to-analog conversion, DAC) to form a to-be-transmitted radio frequency signal. Similarly, after performing corresponding inverse operations on the received radio frequency signal, the receive end obtains actual data content carried in the signal. For example, for OFDM processing at the receive end, operations such as fast Fourier transform (fast Fourier transform, FFT) are required to be performed on the OFDM signal.

In OFDM processing, a to-be-transmitted signal is to be mapped to each subcarrier, and a frequency domain signal aₖ on each subcarrier is converted into a time domain signal s(n) through an inverse fast Fourier transform (inverse fast Fourier transform, IFFT), where n ranges from 0 to N−1. The process may be implemented based on, for example, the following formula:

$$s ( n ) = {\sum }_{k = 0}^{N - 1} {a}_{k} \cdot {e}^{j 2 π n k / N} \qquad ( 1 )$$

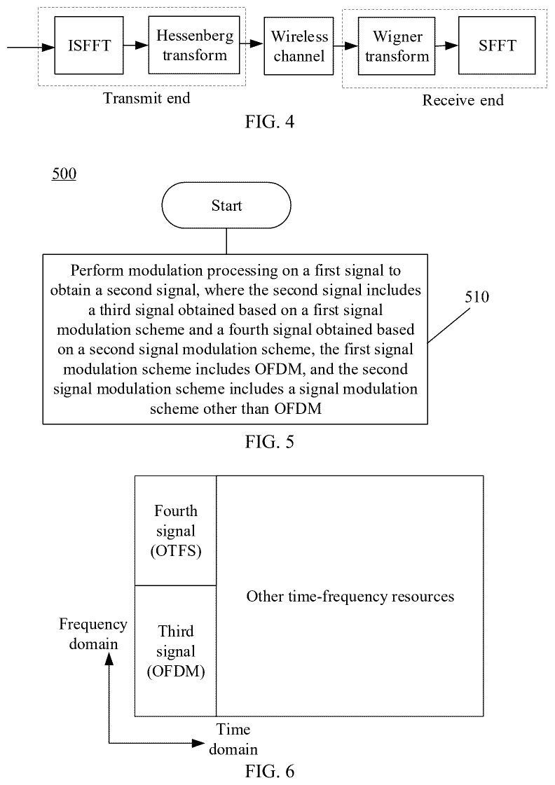

FIG. 4 shows an implementation process of OTFS. OTFS processing at a transmit end successively includes inverse symplectic finite Flourier transform (inverse symplectic finite flourier transform, ISFFT) and Hessenberg transform. OTFS processing at a receive end successively includes Wigner transform and symplectic finite Flourier transform (symplectic finite flourier transform, SFFT). A time-frequency signal may be converted into a delay-Doppler domain signal through ISFFT.

A unit impulse response of a linear time-varying channel may be represented as g(τ, t), where τ is a delay, and t is an instant. Therefore, at an instant t, a relationship between an input and an output of a channel may be represented as:

$$y ( t ) = \int x ( t - τ ) g ( τ , t ) d τ \qquad ( 2 )$$

If Fourier transform of g(τ, t) in time domain is denoted as h(τ, t), the following is obtained:

$$g ( τ , t ) = \int h ( τ , v ) {e}^{j 2 π vt} d v \qquad ( 3 )$$

If x(t) and X(f) are used as a Fourier transform pair, the following is obtained:

$$x ( t - τ ) = \int X ( f ) {e}^{- j 2 π f τ} {e}^{j 2 π f t} df \qquad ( 4 )$$

Formula (4) can be substituted into Formula (2) to obtain:

$$y ( t ) = \int \int g ( τ , t ) X ( f ) {e}^{- j 2 π f τ} {e}^{j 2 π f t} dfd τ = \int X ( f ) H ( f , t ) {e}^{j 2 π f t} df \qquad ( 5 )$$

$$H ( f , t ) = \int g ( τ , t ) e - j 2 π f τ d τ \qquad ( 6 )$$

In this way, the following can be obtained:

$$H ( f , t ) = \int \int h ( τ , v ) {e}^{j 2 π vt - j 2 π f τ} d τ dv \qquad ( 7 )$$

In this way, a relationship described in Formula (7) is satisfied between a signal in time-frequency domain (f, t) and a signal in delay-Doppler domain (τ, v).

If a to-be-transmitted signal is x(k, l), x(k, l) is converted into X(m, n) in TF domain through ISFFT, to obtain a discrete time-frequency signal, where k∈[0, M−1] is a sequence number in delay domain, l∈[0, N−1] is a sequence number in Doppler domain, m indicates a sequence number in frequency domain, and n indicates a sequence number in time domain.

$$X ( m , n ) = \frac{1}{\sqrt{M N}} {\sum }_{k = 0}^{M - 1} {\sum }_{l = 0}^{N - 1} x ( k , l ) \cdot {e}^{- j 2 π ( k m / M - n l / N )} \qquad ( 8 )$$

Then, the discrete time-frequency signal is converted into a continuous time domain signal that can be transmitted by the transmit end.

$$s ( t ) = {\sum }_{m = 0}^{M - 1} {\sum }_{n = 0}^{N - 1} X ( m , n ) {g}_{tx} ( t - nT ) \cdot {e}^{j 2 π m Δ f ( t - nT )} \qquad ( 9 )$$

Herein, gₜₓ(t) is a transmit shaping filter, Δf is a subcarrier spacing, and T is a symbol transmission cycle.

A cyclic prefix is to be added before each symbol for an OTFS signal. This is similar to an OFDM signal. For example, a length of a cyclic prefix and a maximum delay may satisfy: T_{CP}>τₘₐₓ, where T_{CP} is the length of the cyclic prefix, and τₘₐₓ is the maximum delay of signal transmission.

As described above, this embodiment of the present application is based on a scenario in which a plurality of multiple access manners (or multiple waveforms) coexist. Therefore, a problem of how to process a signal in the scenario in which a plurality of multiple access manners (or multiple waveforms) coexist is to be resolved.

Therefore, this embodiment of the present application provides two different signal modulation schemes, that is, a first signal modulation scheme and a second signal modulation scheme, to perform modulation processing on a first signal. An obtained second signal includes a third signal obtained based on the first signal modulation scheme and a fourth signal obtained based on the second signal modulation scheme. Therefore, coordinated transmission of signals in two different modulation schemes is implemented, to facilitate improvement of signal transmission performance.

In this embodiment of the present application, the first signal modulation scheme means OFDM or another time-frequency signal modulation scheme. The second signal modulation scheme means a signal modulation scheme other than OFDM. For example, the second signal modulation scheme may be a signal modulation scheme associated with OTFS or another delay-Doppler signal modulation scheme. For another example, the second signal modulation scheme may be a signal modulation scheme associated with interleaved frequency division multiplexing (Interleaved Frequency Division Multiplexing, IFDM), orthogonal delay-Doppler division multiplexing (Orthogonal Delay-Doppler Division Multiplexing, ODDM), orthogonal chirp division multiplexing (Orthogonal Chirp Division Multiplexing, OCDM), or linear frequency modulation (Linear Frequency Modulation, LFM). The signal modulation scheme in this embodiment of the present application may be, for example, a multi-carrier modulation scheme. The “modulation” described in this embodiment of the present application should be broadly understood as “processing” on a signal.

The following describes embodiments of the present application in detail with reference to FIG. 5.

FIG. 5 is a schematic flowchart of a wireless signal processing method according to an embodiment of the present application. The method 500 shown in FIG. 5 may be performed by a transmit end. The transmit end may be a terminal device. In this case, a receive end may be a network device. Alternatively, the transmit end may be a network device. In this case, a receive end may be a terminal device. The terminal device may be, for example, the terminal device 120 shown in FIG. 1, and the network device may be, for example, the network device 110 shown in FIG. 1.

With reference to FIG. 5, in step 510, modulation processing is performed on a first signal to obtain a second signal.

The second signal includes a third signal obtained based on a first signal modulation scheme and a fourth signal obtained based on a second signal modulation scheme. The first signal modulation scheme includes OFDM. The second signal modulation scheme includes a signal modulation scheme other than OFDM. For example, the second signal modulation scheme is associated with OTFS, IFDM, ODDM, OCDM, or LFM. In other words, the second signal obtained through performing modulation processing on the first signal includes two parts, and signal modulation schemes used for the two parts are different.

The following describes transmission manners of the two parts.

### Manner 1

In Manner 1, the third signal and the fourth signal are transmitted in a frequency division manner (in other words, frequency-domain division).

For example, as shown in FIG. 6, the third signal (that is, an OFDM signal) and the fourth signal (that is, an OTFS signal) are transmitted in the frequency division manner.

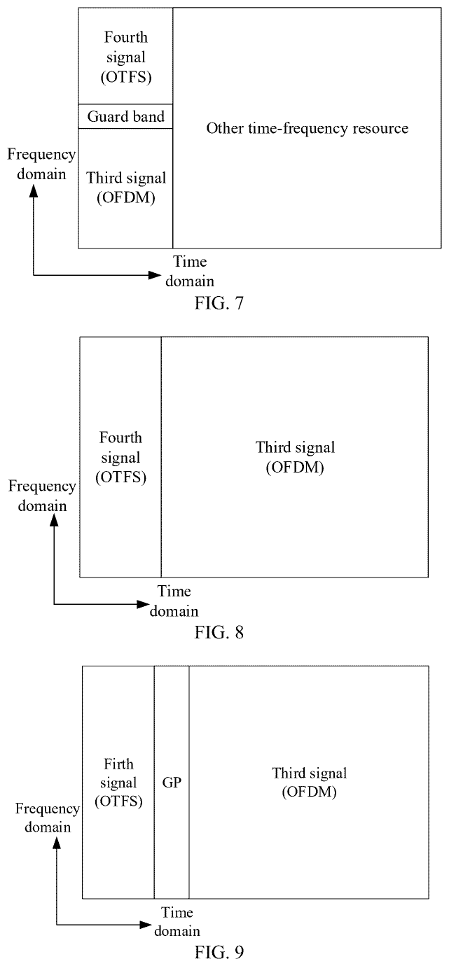

To avoid signal interference between different frequency bands, in some implementations, a guard band is set between frequency resources of the third signal and the fourth signal that are transmitted in the frequency division manner, for example, as shown in FIG. 7.

For example, the first signal modulation scheme and the second signal modulation scheme may be associated with different frequency bands (band). The third signal may be transmitted on a frequency band associated with the first signal modulation scheme, and the fourth signal may be transmitted on a frequency band associated with the second signal modulation scheme.

For example, if the second signal modulation scheme is supported on some frequency bands (in other words, a non-OFDM waveform may exist on these frequency bands), the fourth signal can be transmitted on these frequency bands. For another example, if the second signal modulation scheme is not supported on some frequency bands (in other words, no non-OFDM waveform exists on these frequency bands), the fourth signal cannot be transmitted on these frequency bands. For example, the frequency band is a frequency band shared by 5G and 6G. For better coexistence between 6G and 5G systems, no non-OFDM waveform can be supported on the frequency band. For another example, if the first signal modulation scheme is supported on some frequency bands, the third signal can be transmitted on these frequency bands. For another example, if both the first signal modulation scheme and the second signal modulation scheme are supported on some frequency bands, both the third signal and the fourth signal can be transmitted on these frequency bands.

A frequency resource used to transmit a signal (for example, the fourth signal) obtained based on the second signal modulation scheme may be indicated by the network device to the terminal device. For example, information about the frequency resource may be broadcast in a cell by using system information (for example, a system information block (system information block, SIB1)).

When a specific frequency band is occupied by a non-OFDM signal, a frequency starting point of an OFDM resource used by the terminal device to perform data communication should start from a starting point of an actual OFDM resource. For example, in a case that 0 Hz to 100 Hz is occupied by an OTFS signal when an original frequency starting point F0 of an OFDM resource is 0 Hz, the frequency starting point F0 of the OFDM resource is adjusted to 100 Hz.

### Manner 2

In Manner 2, the third signal and the fourth signal are transmitted in a time division manner (in other words, time-domain division).

For example, as shown in FIG. 8, the third signal (that is, an OFDM signal) and the fourth signal (that is, an OTFS signal) are transmitted in the time division manner.

In some implementations, a guard period (guard period, GP) is set between time resources of the third signal and the fourth signal that are transmitted in the time division manner, for example, as shown in FIG. 9. In this way, a stable transition time can be provided between the OFDM signal and the OTFS signal, to ensure that the two different types of signals are not subject to interference or loss in a transmission process.

For example, the second signal may be located on a specific frequency band. The specific frequency band is a frequency band that is associated with the first signal modulation scheme and the second signal modulation scheme. For example, some specific frequency bands are configured to transmit signals obtained based on the first signal modulation scheme and the second signal modulation scheme. The third signal obtained based on the first signal modulation scheme and the fourth signal obtained based on the second signal modulation scheme may be transmitted on these specific frequency bands in the time division manner.

### Manner 3

In Manner 3, the third signal and the fourth signal are transmitted by using a unified framework (for example, an OFDM framework). For example, an implementation process of the second signal modulation scheme includes a step associated with the first signal modulation scheme (that is, OFDM). In this case, corresponding processing is required to be performed on the fourth signal, so that a signal in a non-OFDM framework is converted to the OFDM framework to be transmitted together with the third signal in the OFDM framework. In this way, a transmit-end device and a receive-end device can better use the two signal modulation schemes without frequent switching between the two signal modulation schemes. In the following, a specific solution of Manner 3 is described by using an example in which the first signal modulation scheme is OFDM and the second signal modulation scheme is associated with OTFS.

In some implementations, in step 510, a process of performing modulation processing on the first signal may include: performing segmentation processing on the first signal to obtain a first part and a second part; performing OFDM processing on the first part to obtain the third signal; and performing symplectic finite Fourier processing and OFDM processing (for example, IFFT) on the second part to obtain the fourth signal. In this case, the first signal modulation scheme may be, for example, an OFDM process including OFDM processing; and the second signal modulation scheme may be associated, for example, with OTFS, and includes processes such as symplectic finite Fourier processing (for example, ISFFT).

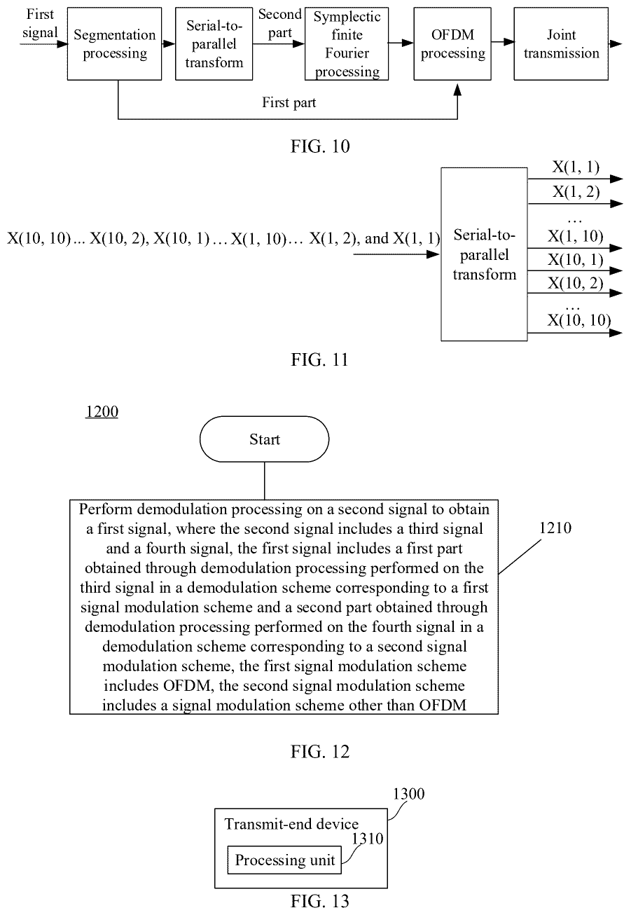

For example, as shown in FIG. 10, the first part and the second part are obtained after segmentation processing is performed on the first signal. OFDM processing is directly performed on the first part. For the second part, symplectic finite Fourier processing (for example, ISFFT) is first performed to convert a delay-Doppler domain signal into a time-frequency signal, so that OFDM processing can be performed on these time-frequency signals. In other words, the first part of the signal is an OFDM signal, and the second part of the signal is an OTFS signal. By performing different processing respectively on the first part and the second part, OFDM signals are finally formed, so that joint transmission of the third signal and the fourth signal in different signal modulation schemes is implemented in the same OFDM framework.

The second part may be, for example, a two-dimensional array that is of delay domain and Doppler domain and that is obtained through serial-to-parallel transform. In other words, before symplectic finite Fourier processing is performed, serial-to-parallel transform is to be performed on a signal, to obtain an input signal, satisfying a requirement, of symplectic finite Fourier processing. For example, as shown in FIG. 11, serial-to-parallel transform may be performed on signals x(10, 10), . . . , x(10, 2), x(10, 1), . . . , x(1, 10), . . . , x(1, 2), and x(1, 1) to obtain a two-dimensional array in delay domain and Doppler domain as input signals of symplectic finite Fourier processing:

x(1, 1);
x(1, 2);
...;
x(1, 10);
x(10, 1);
x(10, 2);
...; and
x(10, 10).

First, how to obtain the third signal after OFDM processing is performed on the first part of the first signal is described. For example, a process of performing OFDM processing on the first part may include performing Fourier processing (for example, IFFT) on the first part to obtain the third signal. For example, the first part is a frequency domain signal, and the third signal is a time domain signal. A process of OFDM processing is equivalent to converting a frequency domain signal into a time domain signal through Fourier processing. For example, reference may be made to Formula (1) above.

Next, how to obtain the fourth signal by performing symplectic finite Fourier processing and OFDM processing on the second part of the first signal is described. For example, a process of performing symplectic finite Fourier processing and OFDM processing on the second part may include:
Step 1-1: Performing symplectic finite Fourier processing on the second part to obtain a discrete time-frequency signal.
Step 1-2: Performing OFDM processing on a discrete time-frequency signal corresponding to each time domain location in the plurality of time domain locations to obtain an OFDM signal corresponding to each time domain location.
Step 1-3: Obtaining the fourth signal based on the plurality of OFDM signals corresponding to the plurality of time domain locations.

For example, the second part is a delay-Doppler domain signal, and the fourth signal is a time domain signal. In this case, in a process in which the second part is processed by using step 1-1 to step 1-3 above to obtain a fourth signal, the second part in delay-Doppler domain is converted into a discrete time-frequency signal through symplectic finite Fourier processing, and the discrete time-frequency signal corresponding to each time domain location is converted into a corresponding OFDM signal through OFDM processing, to form a continuous time domain signal, namely, the fourth signal, based on the OFDM signals corresponding to the plurality of time domain locations. OFDM processing herein is similar to the foregoing OFDM processing, and may indicate a process of Fourier processing (for example, IFFT). For example, reference may be made to Formula (1) above.

In this embodiment of the present application, Fourier processing at the transmit end may be considered as an IFFT process, and Fourier processing at the receive end may be considered as an FFT process, where the FFT process is an inverse process of the IFFT process. In addition, symplectic finite Fourier processing at the transmit end may be considered as an ISFFT process, and symplectic finite Fourier processing at the receive end may be considered as an SFFT process, where the SFFT process is an inverse process of the ISFFT process.

With reference to an example, the following describes in detail step 1-1, step 1-2, and step 1-3.

In step 1-1, the second part and the discrete time-frequency signal satisfy:

$$X ( m , n ) = \frac{1}{\sqrt{MN}} {\sum }_{k = 0}^{M - 1} {\sum }_{l = 0}^{N - 1} x ( k , l ) \cdot {e}^{- j 2 π ( k m / M - n l / N )} \qquad ( 10 )$$

x(k, l) is the second part, X(m, n) is the discrete time-frequency signal, k is a sequence number in delay domain, k∈[0, M−1], l is a sequence number in Doppler domain, l∈[0, N−1], m is a sequence number in frequency domain, m∈[0, M−1], n is a sequence number in time domain, and n∈[0, N−1].

Based on Formula (10), the second part may be converted into a discrete time-frequency signal.

In step 1-2, the OFDM signal corresponding to each time domain location and the discrete time-frequency signal corresponding to each time domain location satisfy:

$$d ( n , t ) = {\sum }_{m = 0}^{M - 1} X ( m , n ) \cdot {e}^{j 2 π m Δ f ( t - nT )} \qquad ( 11 )$$

X(m, n) is a discrete time-frequency signal corresponding to a time domain location n, m is a sequence number in frequency domain, m∈[0, M−1], n is a sequence number in time domain, n∈[0, N−1], d(n, t) is an OFDM signal corresponding to the time domain location n, Δf is a subcarrier spacing, and T is a symbol transmission cycle.

OFDM processing is performed on signals X(m, n) corresponding to the same time domain location n. To be specific, OFDM processing is separately performed on X(m, 1), X(m, 2), . . . , and X(m, N−1) to obtain OFDM signals corresponding to each time domain location n.

$$d ( 1 , t ) = {\sum }_{m = 0}^{M - 1} X ( m , 1 ) \cdot {e}^{j 2 π m Δ f ( t - T )} ;$$

$$d ( 2 , t ) = {\sum }_{m = 0}^{M - 1} X ( m , 2 ) \cdot {e}^{j 2 π m Δ f ( t - 2 T )} ; … ; and$$

$$d ( N - 1 , t ) = {\sum }_{m = 0}^{M - 1} X ( m , N - 1 ) \cdot {e}^{j 2 π m Δ f ( t - 2 T )} .$$

It should be noted that the time domain location is represented by a sequence number n in time domain, and the frequency domain location is represented by a sequence number m in frequency domain. Similarly, sequence numbers k and l respectively exist in delay domain and Doppler domain.

In step 1-3, the fourth signal and the plurality of OFDM signals satisfy:

$$s ( t ) = {\sum }_{n = 0}^{N - 1} d ( n , t ) {g}_{tx} ( t - n T ) \qquad ( 12 )$$

s(t) is the fourth signal, n is a sequence number in time domain, n∈[0, N−1], d(n, t) is an OFDM signal corresponding to a time domain location n, gₜₓ(t−nT) is a shaping filter, and T is a symbol transmission cycle.

In this way, an OFDM signal s(t) can be obtained. The transmitted signal may be considered as a combination of the two OFDM signals (that is, the third signal and the fourth signal). A size of the third signal may be the same as or different from a size of the fourth signal. For example, input data (or output data) may be the same or different.

In specific analysis, in an OTFS process, a continuous time-frequency signal may be obtained through Hessenberg transform. For example, reference may be made to Formula (9).

$$s ( t ) = {\sum }_{m = 0}^{M - 1} {\sum }_{n = 0}^{N - 1} X ( m , n ) {g}_{tx} ( t - nT ) \cdot {e}^{j 2 π m Δ f ( t - nT )} \qquad ( 9 )$$

Herein, gₜₓ(t) is a transmit shaping filter, Δf is a subcarrier spacing, and T is a symbol transmission cycle.

Further, Formula (9) can be transformed to obtain:

$$s ( t ) = {\sum }_{n = 0}^{N - 1} {g}_{tx} ( t - nT ) {\sum }_{m = 0}^{M - 1} X ( m , n ) \cdot {e}^{j 2 π m Δ f ( t - nT )} \qquad ( 13 )$$

It is set that:

$$d ( n , t ) = {\sum }_{m = 0}^{M - 1} X ( m , n ) \cdot {e}^{j 2 π m Δ f ( t - nT )} \qquad ( 11 )$$

Based on Formula (13) and Formula (11), Formula (12) can be obtained:

$$s ( t ) = {\sum }_{n = 0}^{N - 1} d ( n , t ) {g}_{tx} ( t - nT ) \qquad ( 12 )$$

OFDM processing is performed on the first part of the first signal to obtain the third signal in the OFDM framework, and symplectic finite Fourier processing and OFDM processing are performed on the second part of the first signal to obtain the fourth signal in the OFDM framework, to obtain the second signal including the third signal and the fourth signal, thereby implementing combination for radio frequency transmission.

The fourth signal and the third signal may be jointly transmitted in the following manner. For example, the fourth signal and the third signal are transmitted in series. To be specific, two results of OFDM transform shaping are transmitted in series. For another example, a result obtained after an addition operation is performed on the fourth signal and the third signal is used as a to-be-transmitted signal. To be specific, two results of OFDM transform shaping are added and then simultaneously transmitted.

In some implementations, the fourth signal and the third signal may be mapped to different subcarriers for transmission. For example, a same subcarrier size may be configured for each cell. The third signal and the fourth signal are mapped to different subcarriers in the cell. Data sizes (for example, IFFT sizes) when signal processing is performed on the first part and the second part in the first signal may be both determined based on the subcarrier size.

For example, in a case that the fourth signal and the third signal are transmitted in series, time division transmission may be performed between the fourth signal and the third signal; and in a case that the fourth signal and the third signal are added and then transmitted, the fourth signal and the third signal may be mapped to different subcarriers in same OFDM.

Similarly, after modulation processing above is completed, a cyclic prefix is to be added before the second signal on each time domain symbol, where the cyclic prefix is greater than a maximum transmission delay of the second signal. In other words, the foregoing formula T_{CP}>τₘₐₓ is required to be satisfied, where T_{CP} is a length of the cyclic prefix, and τₘₐₓ is the maximum transmission delay of the second signal.

FIG. 12 is a schematic flowchart of a wireless signal processing method according to an embodiment of the present application. The method 1200 shown in FIG. 12 may be performed by a receive end. The receive end may be a terminal device. In this case, a transmit end may be a network device. Alternatively, the receive end may be a network device. In this case, a transmit end may be a terminal device. The terminal device may be, for example, the terminal device 120 shown in FIG. 1, and the network device may be, for example, the network device 110 shown in FIG. 1.

With reference to FIG. 12, in step 1210, demodulation processing is performed on a second signal to obtain a first signal.

The second signal includes a third signal and a fourth signal. The first signal includes a first part obtained through demodulation processing performed on the third signal in a demodulation scheme corresponding to a first signal modulation scheme and a second part obtained through demodulation processing performed on the fourth signal in a demodulation scheme corresponding to a second signal modulation scheme. The first signal modulation scheme includes OFDM. The second signal modulation scheme is associated with a signal modulation scheme (for example, OTFS, IFDM, ODDM, OCDM, or LFM) other than OFDM. In other words, the third signal and the fourth signal in the second signal are demodulated by using different demodulation schemes (that is, the demodulation scheme corresponding to the first signal modulation scheme and the demodulation scheme corresponding to the second signal modulation scheme), to respectively obtain two parts of signals, that is, the first part and the second part. The first part and the second part form a final demodulation signal, that is, the first signal.

In some implementations, the third signal and the fourth signal are transmitted in a frequency division manner. Further, a guard band may be set between frequency resources of the third signal and the fourth signal that are transmitted in the frequency division manner.

In some implementations, the third signal and the fourth signal are transmitted in a time division manner. Further, a guard period may be set between time resources of the third signal and the fourth signal that are transmitted in the time division manner.

For example, the second signal may be located on a specific frequency band. The specific frequency band is a frequency band that is associated with the first signal modulation scheme and the second signal modulation scheme.

In some implementations, an implementation process of the second signal modulation scheme includes a step associated with the first signal modulation scheme (that is, OFDM).

In some implementations, in step 1210, a process of performing demodulation processing on the second signal may include: performing OFDM processing on the third signal to obtain the first part; performing OFDM processing and symplectic finite Fourier processing on the fourth signal to obtain the second part; and performing combination processing on the first part and the second part to obtain the first signal. In this case, the first signal modulation scheme may be, for example, OFDM, and the demodulation scheme corresponding to the first signal modulation scheme may include a process such as OFDM processing (for example, FFT). For example, the second signal modulation scheme may be associated with OTFS, and the demodulation scheme corresponding to the second signal modulation scheme may include a process such as symplectic finite Fourier processing (for example, SFFT).

In some implementations, a process of performing OFDM processing on the third signal may include: performing Fourier processing (for example, FFT) on the third signal to obtain the first part. For example, the third signal is a time domain signal, and the first part is a frequency domain signal.

In some implementations, a process of performing OFDM processing and symplectic finite Fourier processing on the fourth signal may include:
Step 2-1: Obtaining, based on the fourth signal, a plurality of OFDM signals corresponding to a plurality of time domain locations.
Step 2-2: Performing OFDM processing on an OFDM signal corresponding to each time domain location in the plurality of time domain locations to obtain a discrete time-frequency signal corresponding to each time domain location.
Step 2-3: Performing symplectic finite Fourier processing based on the discrete time-frequency signals corresponding to the plurality of time domain locations to obtain the second part.

For example, the fourth signal is a time domain signal, and the second part is a delay-Doppler domain signal.

In some implementations, the second part is a two-dimensional array of delay domain and Doppler domain, and the method 1200 further includes: performing parallel-to-serial transform on the second part, where the second part obtained after parallel-to-serial transform is used to determine the first signal.

In some implementations, the second part and the discrete time-frequency signal satisfy:

$$X ( m , n ) = \frac{1}{\sqrt{MN}} {\sum }_{k = 0}^{M - 1} {\sum }_{l = 0}^{N - 1} x ( k , l ) \cdot {e}^{- j 2 π ( km / M - nl / N )} \qquad ( 10 )$$

x(k, l) is the second part, X(m, n) is the discrete time-frequency signal, k is a sequence number in delay domain, k∈[0, M−1], l is a sequence number in Doppler domain, l∈[0, N−1], m is a sequence number in frequency domain, m∈[0, M−1], n is a sequence number in time domain, and n∈[0, N−1].

In some implementations, the OFDM signal corresponding to each time domain location and the discrete time-frequency signal corresponding to each time domain location satisfy:

$$d ( n , t ) = {\sum }_{m = 0}^{M - 1} X ( m , n ) \cdot {e}^{j 2 π m Δ f ( t - nT )} \qquad ( 11 )$$

X(m, n) is a discrete time-frequency signal corresponding to a time domain location n, m is a sequence number in frequency domain, m∈[0, M−1], n is a sequence number in time domain, n∈[0, N−1], d(n, t) is an OFDM signal corresponding to the time domain location n, Δf is a subcarrier spacing, and T is a symbol transmission cycle.

In some implementations, the fourth signal and the plurality of OFDM signals satisfy:

$$s ( t ) = {\sum }_{n = 0}^{N - 1} d ( n , t ) {g}_{tx} ( t - nT ) \qquad ( 12 )$$

s(t) is the fourth signal, n is a sequence number in time domain, n∈[0, N−1], d(n, t) is a continuous time-frequency signal corresponding to a time domain location n, gₜₓ(t−nT) is a shaping filter, and T is a symbol transmission cycle.

In some implementations, the method 1200 may further include: removing a cyclic prefix before the second signal on each time domain symbol, where the cyclic prefix is greater than a maximum transmission delay of the second signal.

In some implementations, the fourth signal and the third signal are transmitted in series; and/or the fourth signal and the third signal are mapped to different subcarriers for transmission.

In some implementations, a size of the first part is the same as or different from a size of the second part.

It may be understood that a signal demodulation process executed by the receive end may be considered as an inverse process of a modulation process executed by the transmit end. For example, demodulation processing on the fourth signal is used as an example. Step 2-1 may be considered as an inverse process of step 1-1 corresponding to the transmit end. Step 2-2 may be considered as an inverse process of step 1-2 corresponding to the transmit end. Step 2-3 may be considered as an inverse process of step 1-3 corresponding to the transmit end. It should be noted that in this embodiment of the present application, Fourier processing of the transmit end may be considered as an IFFT process, and Fourier processing of the receive end may be considered as an FFT process. The FFT process is an inverse process of the IFFT process. Symplectic finite Fourier processing of the transmit end may be considered as an ISFFT process, and symplectic finite Fourier processing of the receive end may be considered as an SFFT process. The SFFT process is an inverse process of the ISFFT process. Therefore, for detailed content of the foregoing steps of the receive end, reference may be made to the foregoing description of the transmit end. For brevity, details are not described herein again.

The method embodiments of the present application are described in detail above with reference to FIG. 1 to FIG. 12. Apparatus embodiments of the present application are described in detail below with reference to FIG. 13 to FIG. 15. It should be understood that the description of the method embodiments corresponds to the description of the apparatus embodiments, and therefore, for a part that is not described in detail, reference may be made to the foregoing method embodiments.

FIG. 13 is a schematic structural diagram of a transmit-end device according to an embodiment of the present application. The transmit-end device 1300 shown in FIG. 13 may include a processing unit 1310. The processing unit 1310 is configured to perform modulation processing on a first signal to obtain a second signal, where the second signal includes a third signal obtained based on a first signal modulation scheme and a fourth signal obtained based on a second signal modulation scheme, the first signal modulation scheme includes OFDM, and the second signal modulation scheme includes a signal modulation scheme other than OFDM.

In some implementations, the second signal modulation scheme is associated with one or more of OTFS, IFDM, ODDM, OCDM, or LFM.

In some implementations, the third signal and the fourth signal are transmitted in a frequency division manner; or the third signal and the fourth signal are transmitted in a time division manner.

In some implementations, a guard band is set between frequency resources of the third signal and the fourth signal that are transmitted in the frequency division manner; and/or a guard period is set between time resources of the third signal and the fourth signal that are transmitted in the time division manner.

In some implementations, the second signal is located on a specific frequency band, and the specific frequency band is a frequency band that is associated with the first signal modulation scheme and the second signal modulation scheme.

In some implementations, an implementation process of the second signal modulation scheme includes a step associated with the first signal modulation scheme.

In some implementations, the processing unit 1310 is specifically configured to: perform segmentation processing on the first signal to obtain a first part and a second part; perform OFDM processing on the first part to obtain the third signal; and perform symplectic finite Fourier processing and OFDM processing on the second part to obtain the fourth signal.

In some implementations, the first part is a frequency domain signal, and the third signal is a time domain signal.

In some implementations, the processing unit 1310 is specifically configured to perform Fourier processing on the first part to obtain the third signal.

In some implementations, the second part is a delay-Doppler domain signal, and the fourth signal is a time domain signal.

In some implementations, the processing unit 1310 is specifically configured to: perform symplectic finite Fourier processing on the second part to obtain a discrete time-frequency signal; perform OFDM processing on the discrete time-frequency signal corresponding to each time domain location in a plurality of time domain locations to obtain an OFDM signal corresponding to each time domain location; and obtain the fourth signal based on the plurality of OFDM signals corresponding to the plurality of time domain locations.

In some implementations, the second part is a two-dimensional array that is of delay domain and Doppler domain and that is obtained based on serial-to-parallel transform.

In some implementations, the second part and the discrete time-frequency signal satisfy:

$$X ( m , n ) = \frac{1}{\sqrt{MN}} {\sum }_{k = 0}^{M - 1} {\sum }_{l = 0}^{N - 1} x ( k , l ) \cdot {e}^{- j 2 π ( km / M - nl / N )} ,$$

where x(k, l) is the second part, X(m, n) is the discrete time-frequency signal, k is a sequence number in delay domain, k∈[0, M−1], l is a sequence number in Doppler domain, l∈[0, N−1], m is a sequence number in frequency domain, m∈[0, M−1], n is a sequence number in time domain, and n∈[0, N−1].

In some implementations, the OFDM signal corresponding to each time domain location and the discrete time-frequency signal corresponding to each time domain location satisfy:

$$d ( n , t ) = {\sum }_{m = 0}^{M - 1} X ( m , n ) \cdot {e}^{j 2 π m Δ f ( t - nT )} ,$$

where X(m, n) is a discrete time-frequency signal corresponding to a time domain location n, m is a sequence number in frequency domain, m∈[0, M−1], n is a sequence number in time domain, n∈[0, N−1], d(n, t) is an OFDM signal corresponding to the time domain location n, Δf is a subcarrier spacing, and T is a symbol transmission cycle.

In some implementations, the fourth signal and the plurality of OFDM signals satisfy:

$$s ( t ) = {\sum }_{n = 0}^{N - 1} d ( n , t ) {g}_{tx} ( t - nT ) ,$$

where s(t) is the fourth signal, n is a sequence number in time domain, n∈[0, N−1], d(n, t) is an OFDM signal corresponding to a time domain location n, gₜₓ(t−nT) is a shaping filter, and T is a symbol transmission cycle.

In some implementations, the processing unit 1310 is further configured to add a cyclic prefix before the second signal on each time domain symbol, where the cyclic prefix is greater than a maximum transmission delay of the second signal.

In some implementations, the fourth signal and the third signal are transmitted in series; and/or the fourth signal and the third signal are mapped to different subcarriers for transmission.

In some implementations, a size of the third signal is the same as or different from a size of the fourth signal.

It may be understood that the processing unit 1310 may be, for example, a processor 1510. In addition, optionally, the transmit-end device 1300 further includes a transceiver 1530 and a memory 1520. For details, refer to FIG. 15.

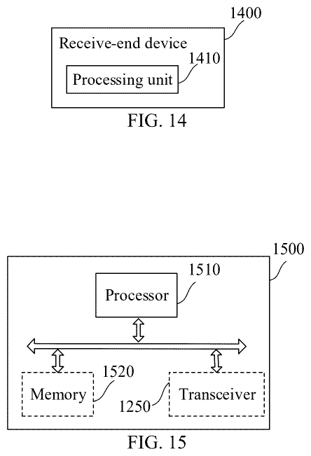

FIG. 14 is a schematic structural diagram of a receive-end device according to an embodiment of the present application. The receive-end device 1400 shown in FIG. 14 may include a processing unit 1410. The processing unit 1410 is configured to perform demodulation processing on a second signal to obtain a first signal, where the second signal includes a third signal and a fourth signal, the first signal includes a first part obtained through demodulation processing performed on the third signal in a demodulation scheme corresponding to a first signal modulation scheme and a second part obtained through demodulation processing performed on the fourth signal in a demodulation scheme corresponding to a second signal modulation scheme, the first signal modulation scheme includes OFDM, and the second signal modulation scheme includes a signal modulation scheme other than OFDM.

In some implementations, the second signal modulation scheme is associated with one or more of OTFS, IFDM, ODDM, OCDM, or LFM.

In some implementations, the third signal and the fourth signal are transmitted in a frequency division manner; or the third signal and the fourth signal are transmitted in a time division manner.

In some implementations, a guard band is set between frequency resources of the third signal and the fourth signal that are transmitted in the frequency division manner; and/or a guard period is set between time resources of the third signal and the fourth signal that are transmitted in the time division manner.

In some implementations, the second signal is located on a specific frequency band, and the specific frequency band is a frequency band that is associated with the first signal modulation scheme and the second signal modulation scheme.

In some implementations, an implementation process of the second signal modulation scheme includes a step associated with the first signal modulation scheme.

In some implementations, the processing unit 1410 is specifically configured to: perform OFDM processing on the third signal to obtain the first part; perform OFDM processing and symplectic finite Fourier processing on the fourth signal to obtain the second part; and perform combination processing on the first part and the second part to obtain the first signal.

In some implementations, the third signal is a time domain signal, and the first part is a frequency domain signal.

In some implementations, the processing unit 1410 is specifically configured to perform Fourier processing on the third signal to obtain the first part.

In some implementations, the fourth signal is a time domain signal, and the second part is a delay-Doppler domain signal.

In some implementations, the processing unit 1410 is specifically configured to: obtain, based on the fourth signal, a plurality of OFDM signals corresponding to a plurality of time domain locations; perform OFDM processing on an OFDM signal corresponding to each time domain location in the plurality of time domain locations to obtain a discrete time-frequency signal corresponding to each time domain location; and perform symplectic finite Fourier processing based on the discrete time-frequency signals corresponding to the plurality of time domain locations to obtain the second part.

In some implementations, the second part is a two-dimensional array of delay domain and Doppler domain, and the processing unit 1410 is further configured to perform parallel-to-serial transform on the second part, where the second part obtained after parallel-to-serial transform is used to determine the first signal.

In some implementations, the second part and the discrete time-frequency signal

$$X ( m , n ) = \frac{1}{\sqrt{MN}} {\sum }_{k = 0}^{M - 1} {\sum }_{l = 0}^{N - 1} x ( k , l ) \cdot {e}^{- j 2 π ( km / M - nl / N )} ,$$

satisfy: where x(k, l) is the second part, X(m, n) is the discrete time-frequency signal, k is a sequence number in delay domain, k∈[0, M−1], l is a sequence number in Doppler domain, l∈[0, N−1], m is a sequence number in frequency domain, m∈[0, M−1], n is a sequence number in time domain, and n∈[0, N−1].

In some implementations, the OFDM signal corresponding to each time domain location and the discrete time-frequency signal corresponding to each time domain location satisfy:

$$d ( n , t ) = {\sum }_{m = 0}^{M - 1} X ( m , n ) \cdot {e}^{j 2 π m Δ f ( t - nT )} ,$$

where X(m, n) is a discrete time-frequency signal corresponding to a time domain location n, m is a sequence number in frequency domain, m∈[0, M−1], n is a sequence number in time domain, n∈[0, N−1], d(n, t) is an OFDM signal corresponding to the time domain location n, Δf is a subcarrier spacing, and T is a symbol transmission cycle.

In some implementations, the fourth signal and the plurality of OFDM signals satisfy:

$$s ( t ) = {\sum }_{n = 0}^{N - 1} d ( n , t ) {g}_{tx} ( t - nT ) ,$$

where s(t) is the fourth signal, n is a sequence number in time domain, n∈[0, N−1], d(n, t) is a continuous time-frequency signal corresponding to a time domain location n, gₜₓ(t−nT) is a shaping filter, and T is a symbol transmission cycle.

In some implementations, the processing unit 1410 is further configured to remove a cyclic prefix before the second signal on each time domain symbol, where the cyclic prefix is greater than a maximum transmission delay of the second signal.

In some implementations, the fourth signal and the third signal are transmitted in series; and/or the fourth signal and the third signal are mapped to different subcarriers for transmission.

In some implementations, a size of the first part is the same as or different from a size of the second part.

It may be understood that the processing unit 1410 may be, for example, a processor 1510. In addition, optionally, the receive-end device 1400 further includes a memory 1520 and a transceiver 1530. For details, refer to FIG. 15.

FIG. 15 is a schematic structural diagram of an apparatus for communication according to an embodiment of the present application. A dashed line shown in FIG. 15 indicates that the unit or the module is optional. The apparatus 1500 may be configured to implement the method described in the foregoing method embodiment. For example, the apparatus 1500 may be a chip, a terminal device, or a network device.

The apparatus 1500 may include one or more processors 1510. The processor 1510 may support the apparatus 1500 in implementing the method described in the foregoing method embodiment. The processor 1510 may be a general-purpose processor or a dedicated purpose processor. For example, the processor 1510 may be a central processing unit (central processing unit, CPU). Alternatively, the processor 1510 may be another general-purpose processor, a digital signal processor (digital signal processor, DSP), an application specific integrated circuit (application specific integrated circuit, ASIC), a field programmable gate array (field programmable gate array, FPGA) or another programmable logic device, a discrete gate or a transistor logic device, a discrete hardware component, or the like. The general-purpose processor may be a microprocessor, or any conventional processor, or the like.

The apparatus 1500 may further include one or more memories 1520. The memory 1520 stores a program, and the program may be executed by the processor 1510, so that the processor 1510 performs the method described in the foregoing method embodiment. The memory 1520 may be separate from the processor 1510 or may be integrated into the processor 1510.

The apparatus 1500 may further include a transceiver 1530. The processor 1510 may communicate with another device or chip by using the transceiver 1530. For example, the processor 1510 may transmit data to and receive data from another device or chip by using the transceiver 1530.

An embodiment of the present application provides a communications system. The communications system includes the foregoing transmit-end device and the foregoing receive-end device. In some implementations, the system further includes another device that interacts with the transmit-end device and the receive-end device.

An embodiment of the present application further provides a computer-readable storage medium for storing a program. The computer-readable storage medium may be applied to the transmit-end device or the receive-end device provided in embodiments of the present application, and the program causes a computer to execute the methods to be performed by the transmit-end device or the receive-end device in embodiments of the present application.

An embodiment of the present application further provides a computer program product. The computer program product includes a program. The computer program product may be applied to the transmit-end device or the receive-end device provided in embodiments of the present application, and the program causes a computer to perform the methods to be performed by the transmit-end device or the receive-end device in embodiments of the present application.

An embodiment of the present application further provides a computer program. The computer program may be applied to the transmit-end device or the receive-end device provided in embodiments of the present application. The computer program causes a computer to perform the methods to be performed by the transmit-end device or the receive-end device in embodiments of the present application.

It should be understood that the terms “system” and “network” in embodiments of the present application may be used interchangeably. In addition, the terms used in the present application are only used to explain the specific embodiments of the present application, and are not intended to limit the present application. In the specification, claims, and accompanying drawings of the present application, the terms “first”, “second”, “third”, “fourth”, and so on are intended to distinguish between different objects but do not describe a particular sequence. In addition, the terms “including” and “having” and any other variants thereof are intended to cover a non-exclusive inclusion.

In embodiments of the present application, “indicate” mentioned herein may be a direct indication, or may be an indirect indication, or may mean that there is an association relationship. For example, A indicates B, which may mean that A directly indicates B, for example, B may be obtained by using A; or may mean that A indirectly indicates B, for example, A indicates C, and B may be obtained by using C; or may mean that there is an association relationship between A and B.

In embodiments of the present application, “B corresponding to A” means that B is associated with A, and B may be determined based on A. However, it should be further understood that determining B based on A does not mean determining B based on only A, but instead B may be determined based on A and/or other information.

In embodiments of the present application, the term “correspond” may mean that there is a direct or indirect correspondence between the two, or may mean that there is an association relationship between the two, or may mean that there is a relationship such as indicating and being indicated, or configuring and being configured.

In embodiments of the present application, “predefined” or “preconfigured” may be implemented by prestoring corresponding code, tables, or other forms that may be used to indicate related information in devices (for example, including a transmit-end device and a receive-end device), and a specific implementation thereof is not limited in the present application. For example, predefining may refer to being defined in a protocol.

In embodiments of the present application, the “protocol” may refer to a standard protocol in the communications field, and may include, for example, an LTE protocol, an NR protocol, and a related protocol applied to a future communications system, which is not limited in the present application.

The term “and/or” in embodiments of the present application describes only an association relationship for describing associated objects and represents that three relationships may exist. For example, A and/or B may represent the following three cases: Only A exists, both A and B exist, and only B exists. In addition, the character “/” in this specification generally indicates an “or” relationship between the associated objects.

In embodiments of the present application, sequence numbers of the foregoing processes do not mean execution sequences. The execution sequences of the processes should be determined according to functions and internal logic of the processes, and should not be construed as any limitation on the implementation processes of embodiments of the present application.

In several embodiments provided in the present application, it should be understood that, the disclosed system, apparatus, and method may be implemented in other manners. For example, the foregoing described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or another form.

The units described as separate parts may or may not be physically separate, and parts displayed as units may or may not be physical units, may be located in one location, or may be distributed on a plurality of network units. A part or all of the units may be selected based on actual requirements to achieve the objectives of the solutions of embodiments.

In addition, functional units in embodiments of the present application may be integrated into one processing unit, or each of the units may exist alone physically, or two or more units may be integrated into one unit.

All or a part of the foregoing embodiments may be implemented by using software, hardware, firmware, or any combination thereof. When the software is used to implement embodiments, all or a part of embodiments may be implemented in a form of a computer program product. The computer program product includes one or more computer instructions. When the computer program instructions are loaded and executed on a computer, the procedures or functions according to embodiments of the present application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (such as a coaxial cable, an optical fiber, and a digital subscriber line (digital subscriber line, DSL)) manner or a wireless (such as infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (digital video disc, DVD)), a semiconductor medium (for example, a solid state drive (solid state drive, SSD)), or the like.

The foregoing descriptions are merely specific implementations of the present application, but the protection scope of the present application is not limited thereto. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A signal processing method, comprising:
performing modulation processing on a first signal to obtain a second signal, wherein
the second signal comprises a third signal obtained based on a first signal modulation scheme and a fourth signal obtained based on a second signal modulation scheme, the first signal modulation scheme comprises orthogonal frequency division multiplexing (OFDM), and the second signal modulation scheme comprises a signal modulation scheme other than OFDM.

2. The method according to claim 1, wherein the second signal modulation scheme is associated with one or more of following:
orthogonal time frequency space (OTFS);
interleaved frequency division multiplexing (IFDM);
orthogonal delay-Doppler multiplexing (ODDM);
orthogonal chirp division multiplexing (OCDM); or
linear frequency modulation (LFM).

3. The method according to claim 1, wherein
the third signal and the fourth signal are transmitted in a frequency division manner; or
the third signal and the fourth signal are transmitted in a time division manner.

4. The method according to claim 3, wherein a guard band is set between frequency resources of the third signal and the fourth signal that are transmitted in the frequency division manner; or a guard period is set between time resources of the third signal and the fourth signal that are transmitted in the time division manner.

5. The method according to claim 1, wherein the second signal is located on a specific frequency band, and the specific frequency band is a frequency band that is associated with the first signal modulation scheme and the second signal modulation scheme.

6. The method according to claim 1, wherein an implementation process of the second signal modulation scheme comprises a step associated with the first signal modulation scheme.

7. The method according to claim 1, wherein the performing modulation processing on a first signal to obtain a second signal comprises:
performing segmentation processing on the first signal to obtain a first part and a second part;
performing OFDM processing on the first part to obtain the third signal; and
performing symplectic finite Fourier processing and OFDM processing on the second part to obtain the fourth signal.

8. The method according to claim 7, wherein the second part is a delay-Doppler domain signal, the fourth signal is a time domain signal, and the performing symplectic finite Fourier processing and OFDM processing on the second part to obtain the fourth signal comprises:
performing symplectic finite Fourier processing on the second part to obtain a discrete time-frequency signal;
performing OFDM processing on the discrete time-frequency signal corresponding to each time domain location in a plurality of time domain locations to obtain an OFDM signal corresponding to each time domain location; and
obtaining the fourth signal based on the plurality of OFDM signals corresponding to the plurality of time domain locations.

9. The method according to claim 8, wherein the second part and the discrete time-frequency signal satisfy:
$$X ( m , n ) = \frac{1}{\sqrt{MN}} {\sum }_{k = 0}^{M - 1} {\sum }_{l = 0}^{N - 1} x ( k , l ) \cdot {e}^{- j 2 π ( \frac{km}{M} nl / N )} ,$$
wherein
x(k, l) is the second part, X(m, n) is the discrete time-frequency signal, k is a sequence number in delay domain, k∈[0, M−1], l is a sequence number in Doppler domain, l∈[0, N−1], m is a sequence number in frequency domain, m∈[0, M−1], n is a sequence number in time domain, and n∈[0, N−1].

10. The method according to claim 8, wherein the OFDM signal corresponding to each time domain location and the discrete time-frequency signal corresponding to each time domain location satisfy:
$$d ( n , t ) = {\sum }_{m = 0}^{M - 1} X ( m , n ) \cdot {e}^{j 2 π m Δ f ( t - nT )} ,$$
X(m, n) is a discrete time-frequency signal corresponding to a time domain location n, m is a sequence number in frequency domain, m∈[0, M−1], nis a sequence number in time domain, n∈[0, N−1], d(n, t) is an OFDM signal corresponding to the time domain location n, Δf is a subcarrier spacing, and T is a symbol transmission cycle.

11. The method according to claim 8, wherein the fourth signal and the plurality of OFDM signals satisfy:
$$s ( t ) = {\sum }_{n = 0}^{N - 1} d ( n , t ) {g}_{tx} ( t - nT ) ,$$
s(t) is the fourth signal, n is a sequence number in time domain, n∈[0, N−1], d(n, t) is an OFDM signal corresponding to a time domain location n, gₜₓ(t−nT) is a shaping filter, and T is a symbol transmission cycle.

12. The method according to claim 7, wherein
the fourth signal and the third signal are transmitted in series; or
the fourth signal and the third signal are mapped to different subcarriers for transmission.

13. The method according to claim 7, wherein a size of the third signal is the same as or different from a size of the fourth signal.

14. A signal processing method, comprising:
performing demodulation processing on a second signal to obtain a first signal, wherein
the second signal comprises a third signal and a fourth signal, the first signal comprises a first part obtained through demodulation processing performed on the third signal in a demodulation scheme corresponding to a first signal modulation scheme and a second part obtained through demodulation processing performed on the fourth signal in a demodulation scheme corresponding to a second signal modulation scheme, the first signal modulation scheme comprises orthogonal frequency division multiplexing (OFDM), and the second signal modulation scheme comprises a signal modulation scheme other than OFDM.

15. An apparatus, comprising:
at least one processor; and
one or more non-transitory computer-readable storage media coupled to the at least one processor and storing programming instructions for execution by the at least one processor, wherein the programming instructions, when executed, cause the apparatus to perform operations comprising:
performing modulation processing on a first signal to obtain a second signal, wherein
the second signal comprises a third signal obtained based on a first signal modulation scheme and a fourth signal obtained based on a second signal modulation scheme, the first signal modulation scheme comprises orthogonal frequency division multiplexing (OFDM), and the second signal modulation scheme comprises a signal modulation scheme other than OFDM.

16. The apparatus according to claim 15, wherein the second signal modulation scheme is associated with one or more of following:
orthogonal time frequency space (OTFS);
interleaved frequency division multiplexing (IFDM);
orthogonal delay-Doppler multiplexing (ODDM);
orthogonal chirp division multiplexing (OCDM); or
linear frequency modulation (LFM).

17. The apparatus according to claim 15, wherein
the third signal and the fourth signal are transmitted in a frequency division manner; or
the third signal and the fourth signal are transmitted in a time division manner.

18. The apparatus according to claim 17, wherein a guard band is set between frequency resources of the third signal and the fourth signal that are transmitted in the frequency division manner; or a guard period is set between time resources of the third signal and the fourth signal that are transmitted in the time division manner.

19. The apparatus according to claim 15, wherein the second signal is located on a specific frequency band, and the specific frequency band is a frequency band that is associated with the first signal modulation scheme and the second signal modulation scheme.

20. The apparatus according to claim 15, wherein an implementation process of the second signal modulation scheme comprises a step associated with the first signal modulation scheme.
